(19) United States
(12) Patent Application Publication
(10) Pub. No.: US 2010/0001239 A1
(43) Pub. Date: Jan. 7, 2010

(54) Motorcycle Jack

(76) Inventor: Lee Dufour, Toronto (CA)

Correspondence Address: Nasser Ashgriz;Heydary Hamilton PC, Suite 1200, 439 University Ave, Toronto, ON, M5G 1Y8, CA

(21) Appl. No.: 12/168,096

(22) Filed: Jul. 4, 2008

(51) Int. Cl. B66F 3/08

(52) U.S. Cl. 254/100

(57) ABSTRACT

The present invention relates to a compact and portable motorcycle jacks comprising a turnbuckle mechanism. The present jack is a new use of an old device, said device being a turnbuckle, and said turnbuckle engaging with ground from one end and with the motorcycle swing bar on the other end. Whereas turning of the turnbuckle will lift the motorcycle. Turnbuckles are simple devices which are portable and can be easily located inside the motorcycle.

### FIELD OF THE INVENTION

The present invention is a jack or a lifting device for light weight vehicles, in particular for motorcycles. The disclosed jack is a turnbuckle which engages with the motorcycle from one end and the ground from the other end. The present jack is small, portable and easily handled by a single person

### BACKGROUND OF THE INVENTION

Motorcycles have very limited space and any invention that can reduce the size and the weight of the load that must be carried with a motorcycle is desired. One of the essential devices that a biker needs to carry along is a jack. A jack is used to perform various types of repair on the motorcycle, such as repairing a flat tire, maintenance of chains and belts, etc To repair a flat tire, the motorcycle wheel has to be lifted above the ground. In addition, during a long distance travel, motorcycle chain or belt drives have to be lubricated regularly. For this matter, the motorcycle's rear wheel and rear drive sprocket have to be lifted above the ground for complete rotation. Some motorcycles have a center stand fitted to the underside of the chassis to allow for lifting the motor cycle. However, many do not have such a system. For such motorcycles a jack is usually used to lift the motorcycle Therefore, a compact and light weight jack is desirable

Several motorcycle jacks have been disclosed in the prior art that allow for lifting the motorcycle and performing the necessary maintenance. However, all available motorcycle jacks are relatively bulky, heavy and difficult to carry along. It is the intend of the present invention to provide a motorcycle jack which is compact and does not take much space and therefore can be carried along easily. The size of the present jack is small enough that it can be stored underneath the seat of the motorcycle None of the prior art jacks are as simple, as portable, as light weight as the present invention

### SUMMARY OF THE INVENTION

The present invention is a new use of an old device. The new use being a jack or lifting device for light weight vehicles such as a motorcycle, and the old device being a type of a turnbuckle. Turnbuckles are generally comprised of a pair of externally threaded rods or screws, and a screw receiving sleeve. The rods have opposite threads: one rod having right handed threads and the other one having left handed threads Also, the sleeve has internally threaded ends which can receive a screw from its each end. One end of the sleeve has a right handed thread and the other end has a left handed thread Therefore, rotating the sleeve in one direction draws the screws towards one another and rotating it in the reverse direction separates them As the turnbuckle is extended, it engages with the motorcycle, thereafter, further extension of the turnbuckle lifts the motorcycle

Turnbuckles can be made from any high strength material, preferably of high strength steel. There are also a wide variety of turn buckles; however, their main function is to move two screws towards and away from each other.

Several prior art patents have disclosed motorcycle jacks which are compact and relatively light weight For instance, U.S. Pat. No. 6,581,784 issued to Pino disclosed a lever-type jack which has a rigid connecting rod and a motorcycle support rod connected between side plates and has a lever handle, the device inserted under a motorcycle with the connecting rod and support rods both on the ground surface, the motorcycle rod being elevated and the lever handle is rotated, the motorcycle frame being lifted as the motorcycle rod becomes vertically oriented over the support rod. U.S. Pat. No. 6,464,207 issued to Creel and U.S. Pat. No. 5,979,878 issued to Blankenship involve lifting devices that have parallel support arms that lift the motorcycle above the devices as the parallel arms with an upper support plate are moved into a vertical orientation by a lever arm (Creel) or a contact plate attached to cables connected to the parallel arms (Blankenship). A pivotal rotating support surface placed under a motorcycle frame and raised using a wrench, the support stand having feet which may be adjusted to height U.S. Pat. No. 4,580,804 issued to Weber is a pair of legs which are pivotally attached to a motorcycle frame that may be dropped down from the frame for a two leg support and retracted back into a horizontal stored position against the motorcycle frame using a spring retracting means. The legs appear to have some adjustment ability for length using a locking telescopic means.

U.S. Pat. No. 6,073,915 issued to Taylor is an A-frame jack which elevates as the two A-frame legs are moved closer together, with the fulcrum between the two legs being attached to a motorcycle frame, the legs being urged together and apart by a turnbuckle between the two legs, although not clearly shown in that patent In U.S. Pat. No. 5,816,561 issued to Kinsel, a compact and portable motorcycle jack stored in a tow sack, is assembled with two threaded post members engaging a cross bar assembly, the cross bar being raised on the threaded post members by the turning of actuating nuts below the cross bar assembly.

One object of the present invention is to provide a portable and lightweight lifting device for lightweight vehicles, especially for motorcycles.

Another object of the present invention is to provide a low cost jack Most available jacks are mechanically complex, which make their fabrication relatively expensive

Other aspects and features of the present invention will become apparent to those of ordinary skill in the art upon review of the following description of specific embodiments of the invention in conjunction with the accompanying figures

### BRIEF DESCRIPTION OF THE DRAWINGS

In the figures, which illustrate, by way of example only, embodiments of the present invention,

FIG. 1 shows a lifting device for a motorcycle jack embodying the present invention;

FIG. 2 shows the jack in a lifted position; and

FIG. 3 shows a jack embodying the present invention attached to a motorcycle wheel and in an initial position.

### DETAILED DESCRIPTION OF THE INVENTION

Before explaining the present embodiments in detail, it is to be understood that the embodiments are not limited to the particular embodiments and that it can be practiced or carried out in various ways

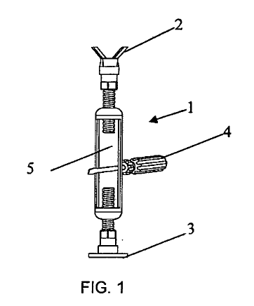

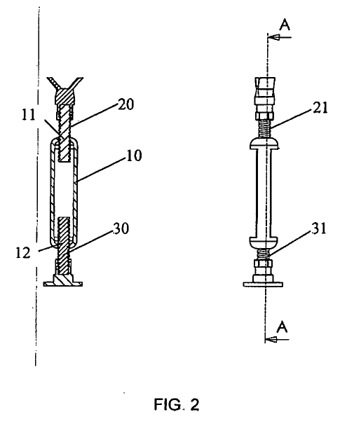

As can be seen from FIGS. 1 and 2, a jack embodying the present invention comprises a turnbuckle 1. The turnbuckle has a motorcycle engaging member 2 and a ground engaging member 3. The motorcycle engaging member can engage with the swing arm of the motorcycle or any other locations on the motorcycle suitable for lifting

FIG. 2 shows details of the turnbuckle used in one embodiment of the present invention Turnbuckle has a body 10, which can have many different shapes. The embodiment in FIGS. 1 and 2 show an open body having only a small portion connecting the two ends of the body. This reduces the weight of the turnbuckle, and allows for using a tool to turn the turnbuckle. The turnbuckle can be turned with hand or any rigid tool For example, FIG. 1 shows a screw driver which is inserted into the opening of the turnbuckle and it used to turn the turnbuckle

The body of the turnbuckle can also be closed, rather than open, and be tubular, rectangular, triangular, or any other shape that is suitable for grabbing its body with hand for turning purposes Turnbuckle body has two ends, 11 and 12, each end having an aperture. One aperture of one end has left handed threads and the other has right handed threads.

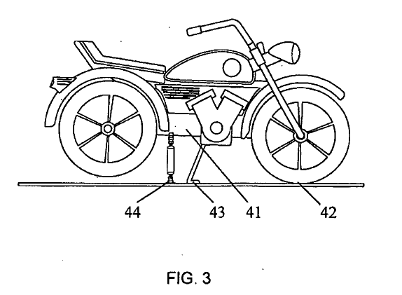

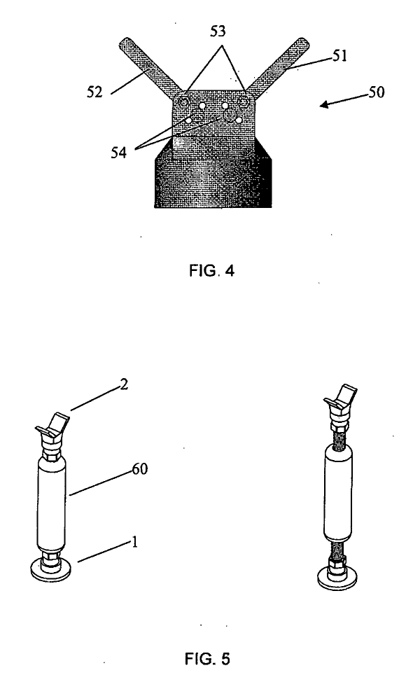

Two draw rods 20 and 30 with exterior screw threads, 21 and 31 are screwed into the body 10, through apertures 11 and 12 One draw rod, 20 engages with the motorcycle and has a motorcycle engaging part 2 and the other draw rod 30 has a ground support part, 3, which sits on the ground. In order to lift the motorcycle, the turnbuckle is located underneath the swing arm 41 of the motorcycle as shown in FIG. 3. The motorcycle is then lifted by turning the turnbuckle so that it extends from the ground to the swing. It is appreciated that the jack can be fitted to any other desired part of the motorcycle, provided that said part is capable of handling the lifting force Many motorcycles have a special bracket rigidly attached to them to be used as a lifting point The length of the disclosed device can vary to accommodate various motorcycles and light vehicles A vehicle needs to be lifted by only few millimeters. Therefore, the screws need to be extended by only a small length to lift the vehicle to the desired level. The jack is part of a three point base, the front wheel being one base 42, the kick stand 43 being the second based and the jack 44 being the third base, giving proper stability for the lifted vehicle. FIG. 3 illustrates a three point lifting process.

The motorcycle engaging part 2 shown in FIGS. 1 and 2 is a simple V-shaped part which engages with a part of a motorcycle The engaging part 2 is replaceable and other parts to better fit different motorcycles can be attached. A universal engagement part 50 is shown in FIG. 4, in which the sides of the part, 51 and 52, can be adjusted using the provided nuts and bolds, 53 and 54. The motorcycle engaging member as well as the ground engaging member can be removable screwed onto the screw rods of the turnbuckle Different types of engaging members can be used for different types of motorcycles and for engaging to different parts of the motorcycle. Also, the ground engaging member can be of any type known to the art that can provide more stability to the lifted vehicle.

In another embodiment of the same invention, the turnbuckle comprises of a closed but hollow body or a sleeve 60 and shown in FIG. 5 Similar to the first embodiment, shown in FIG. 1, said sleeve having two apertures at its two ends. Said sleeve is made of a high strength metal or any other high strength metal like material Two threaded rods or screws enter the ends of the sleeve The outer surface of the sleeve is mainly cylindrical. The apertures of the sleeve have interior threads to receive the rods

A jack embodying the present invention has the significant advantage that it can be operated safely and efficiently by one person The embodiment described is also very compact, which enables the jack to be stored beneath the seat of the motorcycle, or in the luggage of the motorcycle rider. In addition, the separate support and lifting assemblies of the jack enable the jack to be used on most road surfaces, including those having cambers. Additionally, it may be used to provide stability when the motorcycle is parked or to support the motorcycle when it is not in use so that distortion of the front and/or rear tire can be prevented

What is claimed is:

1. A motorcycle jack comprising:
a turnbuckle having a first end screw and a second end screw and a coupling sleeve having a first end and a second end;
said first and second end screws are externally threaded and have opposing threads that allow the turning and raising;
said first and second ends of said coupling sleeve are internally threaded, said first end screw is screwed into said first end of said sleeve, and said second end screw is screwed into said second end of said sleeve;
said first end screw having an engagement member to engage with a motorcycle; and
said second end screw having engagement member to engage to the ground,
wherein the motorcycle is raised above the ground by turning said sleeve in one direction

2. A motorcycle jack of claim 1 having a partially open sleeve

3. A motorcycle jack of claim 1 having a closed sleeve

4. A motorcycle jack of claim 1 having hand holding means on its body to allow for simple hand turning of the turnbuckle

5. A motorcycle jack of claim 1 having an adjustable motorcycle engaging member to engage with different types and different parts of a motorcycle.

6. A method of lifting light weight vehicles and motorcycles using a linear turnbuckle comprising of vertically placing the turnbuckle under the vehicle and turning the turnbuckle to engage the vehicle and the ground, and further turning the turnbuckle to raise the vehicle.
